(19) United States
(12) Patent Application Publication
(10) Pub. No.: US 2017/0254897 A1
(43) Pub. Date: Sep. 7, 2017

(54) SYSTEMS AND METHODS FOR REMOTE MONITORING WITH RADAR

(71) Applicant: GM GLOBAL TECHNOLOGY OPERATIONS LLC, Detroit, MI (US)

(72) Inventors: Eviatar TRON, Tel Aviv (IL); Igal BILIK, Rehovot (IL); Mario JODORKOVSKY, Nesher (IL)

(73) Assignee: GM GLOBAL TECHNOLOGY OPERATIONS LLC, Detroit, MI (US)

(21) Appl. No.: 15/445,768

(22) Filed: Feb. 28, 2017

Related U.S. Application Data
(60) Provisional application No. 62/302,513, filed on Mar. 2, 2016.

(51) Int. Cl. G01S 13/87; G01S 13/89

(52) U.S. Cl. CPC G01S 13/87; G01S 13/89; B60K 28/16

(57) ABSTRACT

Methods and systems are provided for mobile platforms. A mobile platform comprises a body and a radar system. The body includes a wheel assembly, and the radar system is installed on the wheel assembly.

### CROSS-REFERENCE TO RELATED APPLICATIONS

This application claims priority to U.S. Provisional Patent Application No. 62/302,513, filed Mar. 2, 2016, the entire contents of which are hereby incorporated by reference.

### TECHNICAL FIELD

The present disclosure generally relates to radar systems, and more particularly relates to methods and radar systems for remote monitoring.

### BACKGROUND

Certain mobile platforms today, such as automobiles, trucks, buses, motorcycles, trains, marine vessels, aircraft, rotorcraft, and the like, today utilize radar systems. For example, certain mobile platforms utilize radar systems to detect other mobile platforms, pedestrians, or other objects on a path in which the mobile platform is travelling. Radar systems may be used in this manner, for example, in implementing automatic braking systems, adaptive cruise control, and avoidance features, among other mobile platform features. Thus, radar systems are typically employed to monitor conditions surrounding the mobile platform.

Accordingly, it is desirable to provide radar systems for monitoring conditions of the mobile platform. It is also desirable to provide methods, systems, and mobile platforms utilizing such techniques. Furthermore, other desirable features and characteristics of the present invention will be apparent from the subsequent detailed description and the appended claims, taken in conjunction with the accompanying drawings and the foregoing technical field and background.

### SUMMARY

In accordance with an exemplary embodiment, a mobile platform is provided. The mobile platform comprises a body and a radar system. The body includes a wheel assembly, and the radar system is coupled to the wheel assembly.

In accordance with an exemplary embodiment, a method is provided. The method includes transmitting radar signals via a transmitter installed on a wheel assembly of a mobile platform, receiving, via a receiver installed on the wheel assembly, the radar signals after the radar signals have contacted an object, and making determinations, via a processor, regarding one or more mobile platform parameters based on the received radar signals.

### DESCRIPTION OF THE DRAWINGS

The present disclosure will hereinafter be described in conjunction with the following drawing figures, wherein like numerals denote like elements, and wherein:

FIG. 1 is a functional block diagram of a mobile platform having a control system, including a radar control system, installed within a wheel assembly of the mobile platform, in accordance with an exemplary embodiment;

FIG. 2 is a functional block diagram of the radar control system of the mobile platform of FIG. 1, in accordance with an exemplary embodiment;

FIG. 3 is a functional block diagram of a transmission channel and a receiving channel of the radar control system of FIGS. 1 and 2, in accordance with an exemplary embodiment;

FIGS. 4-6 are schematic diagrams of installation of a radar system at various specific locations on the wheel assembly, which can be implemented in connection with the mobile platform of FIG. 1 and the radar control system of FIGS. 1-3, in accordance with various exemplary embodiments;

FIG. 7 is a schematic diagram of a tire as implemented in connection with the wheel assembly having the radar system installed therein of FIG. 1, which can be implemented in connection with the mobile platform of FIG. 1, the radar control system of FIGS. 1-3, and the installations of FIGS. 4-6, in accordance with various exemplary embodiments;

FIG. 8 is an illustration of various parameters that may be determined via the mobile platform of FIG. 1, the radar control system of FIGS. 1-3, the installations of FIGS. 4-6, and the tire of FIG. 7, in accordance with various exemplary embodiments; and

FIG. 9 is flowchart of a process for remote monitoring using a radar control system installed within a wheel assembly of a mobile platform, and that can be implemented in connection with the mobile platform of FIG. 1, the radar control system of FIGS. 1-3, the installations of FIGS. 4-6, and the tire of FIG. 7, in accordance with various exemplary embodiments.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

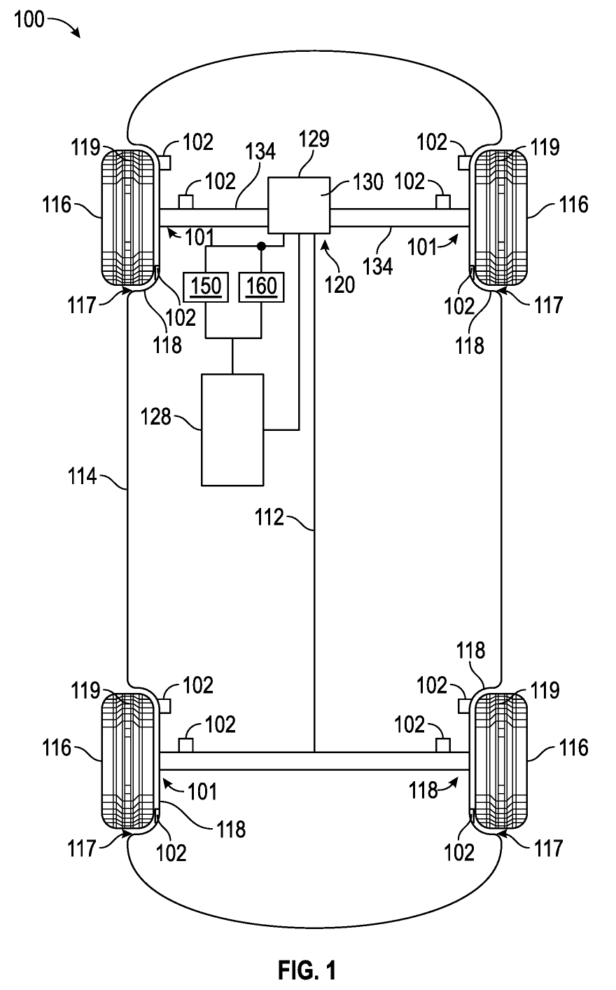

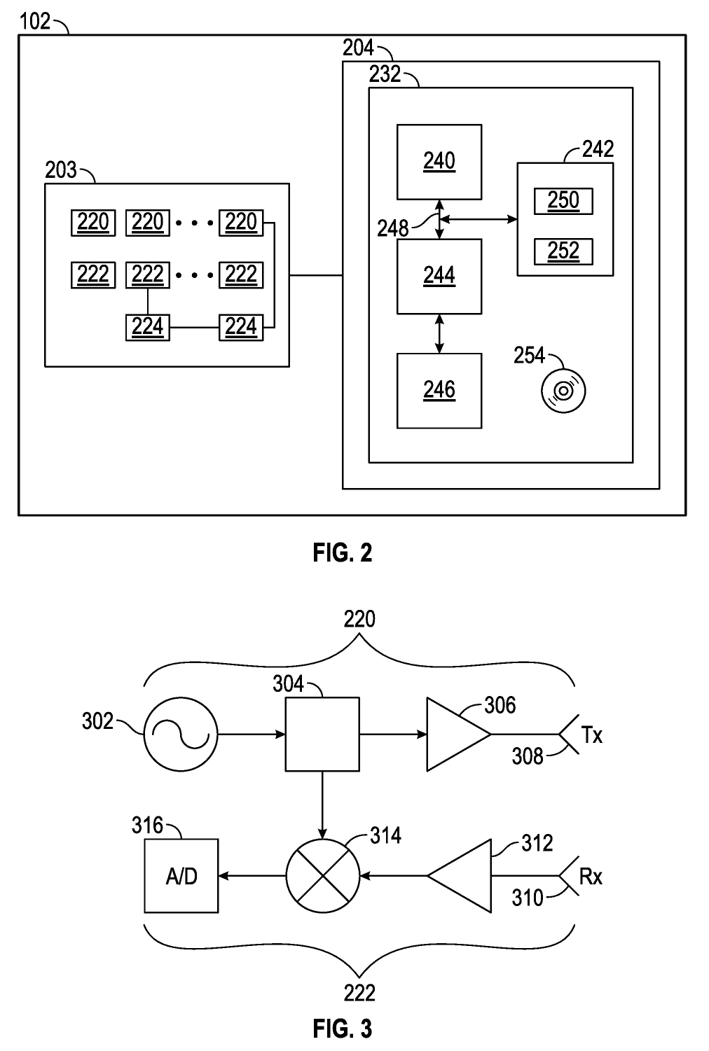

FIG. 1 provides a functional block diagram of mobile platform 100 having a wheel assembly 101 and a radar control system 102 is coupled to the wheel assembly 101, in accordance with an exemplary embodiment. As depicted in FIG. 2 and described in further detail greater below, in one embodiment the radar control system 102 of the mobile platform 100 includes a radar system 203 and a control module (or controller) 204.

In the example of FIG. 1, the exemplary mobile platform 100 is a vehicle (such as an automobile). It should be understood, however, that the various teachings of the present disclosure are not limited to a vehicle, but can be employed on any suitable mobile platform, such as automobiles, trucks, buses, motorcycles, trains, marine vessels, aircraft, rotorcraft and the like. Moreover, while the following description describes the use of the radar control system 102 to observe and monitor a condition associated with the wheel assembly 101 of the mobile platform 100, it should be noted that the teachings of the present disclosure are not so limited. In this regard, the radar control system 102 can be used to monitor various other conditions associated with a mobile platform 100, such as the vehicle, including, but not limited to, a condition of a windshield wiper assembly, a condition of a damper associated with a suspension system, or the like.

In the depicted embodiment, the mobile platform 100 also includes a chassis 112, a body 114, four wheels 116, an electronic control system 128, a steering system 150, and a braking system 160. The body 114 is arranged on the chassis 112 and substantially encloses the other components of the mobile platform 100. The body 114 and the chassis 112 may jointly form a frame. The wheels 116 are each rotationally coupled to the chassis 112 near a respective corner of the body 114.

In the embodiment depicted in FIG. 1, the mobile platform 100 includes an actuator assembly 120. The actuator assembly 120 includes at least one propulsion system 129 mounted on the chassis 112 that drives the wheels 116. In the depicted embodiment, the actuator assembly 120 includes an engine 130. In one embodiment, the engine 130 comprises a combustion engine. In other embodiments, the actuator assembly 120 may include one or more other types of engines and/or motors, such as an electric motor/generator, instead of or in addition to the combustion engine.

Still referring to FIG. 1, the engine 130 is coupled to at least some of the wheels 116 through one or more drive shafts 134 and a respective knuckle. In some embodiments, the engine 130 is also mechanically coupled to a transmission. In other embodiments, the engine 130 may instead be coupled to a generator used to power an electric motor that is mechanically coupled to a transmission.

The steering system 150 is mounted on the chassis 112, and controls steering of the wheels 116. The steering system 150 includes a steering wheel and a steering column (not depicted). The steering wheel receives inputs from a driver of the mobile platform 100. The steering column results in desired steering angles for the wheels 116 via the drive shafts 134 based on the inputs from the driver.

The braking system 160 is mounted on the chassis 112, and provides braking for the mobile platform 100. The braking system 160 receives inputs from the driver via a brake pedal (not depicted), and provides appropriate braking via brake units (also not depicted). The driver also provides inputs via an accelerator pedal (not depicted) as to a desired speed or acceleration of the mobile platform 100, as well as various other inputs for various devices and/or systems, such as one or more radios, other entertainment or infotainment systems, environmental control systems, lightning units, navigation systems, and the like (not depicted in FIG. 1).

As depicted in FIG. 1, the wheel assembly 101 includes the above referenced wheels 116 and drive shafts (axles) 134. In addition, in the depicted embodiment, for each of the wheels 116, the wheel assembly 101 includes a wheel well formed in the body 114 for housing the wheel 116, a fender 118 formed in the body 114 proximate the wheel well 117, and a tire 119 mounted on the wheel. In certain embodiments, the fender 118 may be considered part of the wheel well 117. In various embodiments, the radar control systems 102 are mounted at one or more locations of the wheel assembly 101 proximate the wheels 116. In one embodiment, each radar system 102 has its own control unit. In other embodiments, each radar system 102 may use a central control unit. In certain embodiments, the radar control systems 102 are mounted on the drive shafts (axles) 134 proximate the wheels 116. Also in certain embodiments, the radar control systems 102 are mounted on the fender 118 proximate the wheels 116. In other embodiments, the radar control systems 102 may be installed within the wheel well 117. In one embodiment, each radar control system 102 faces a respective one of the tires 119. In certain embodiments, one or more of the radar control systems 102 also face a path (e.g. a road) on which the mobile platform 100 travels.

With reference to FIG. 2, a functional block diagram is provided for an exemplary radar control system 102 of FIG. 1, in accordance with an exemplary embodiment. While one exemplary radar control system 102 is depicted in FIG. 2, it will be appreciated that each of the various radar control systems 102 of FIG. 1 may be identical or similar to the exemplary embodiment depicted in FIG. 2. As noted above, the radar control system 102 includes the radar system 203 and the controller 204 as depicted in FIG. 2, in accordance with one embodiment.

As depicted in FIG. 2, the radar system 203 includes one or more transmitters 220, one or more receivers 222, a memory 224, and a processing unit 226. In the depicted embodiment, the radar system 203 comprises a multiple input, multiple output (MIMO) radar system with multiple transmitters (also referred to herein as transmission channels) 220 and multiple receivers (also referred to herein as receiving channels) 222. However, this may vary in other embodiments. For example, in certain embodiments, a single transmitter 220 and/or a single receiver 222 may be utilized, and/or any number of transmitters 220 and receivers 222 may be utilized. The transmitters 220 transmit radar signals for the radar system 203. In certain embodiments, the transmitters 220 transmit radar signals toward a sidewall of the tires 119 of FIG. 1. Also in certain embodiments, the transmitters 220 transmit radar signals toward a patch (e.g. a tread region with an interior metallic mesh component) of the tires 119 of FIG. 1. In addition, in certain embodiments, the transmitters 220 transmit radar signals toward a path or road on which the mobile platform 100 travels. After the transmitted radar signals contact one or more objects (such as one of the tires 119 or a path or road on which the mobile platform 100 is travelling), the radar signals are reflected/redirected toward the radar system 203, and the redirected radar signals are received by the receivers 222 of the radar system 203 for processing.

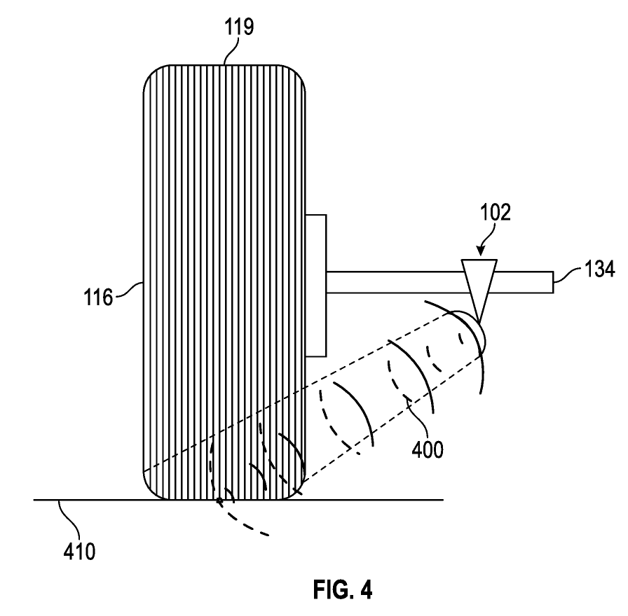

With reference to FIG. 3, a representative one of the transmission channels 220 is depicted along with a respective one of the receiving channels 222 of the radar system of FIG. 3, in accordance with an exemplary embodiment. As depicted in FIG. 3, each transmitting channel 220 includes a signal generator 302, a filter 304, an amplifier 306, and an antenna 308. Also as depicted in FIG. 3, each receiving channel 222 includes an antenna 310, an amplifier 312, a mixer 314, and a sampler/digitizer 316. In certain embodiments the antennas 308, 310 may comprise a single antenna, while in other embodiments the antennas 308, 310 may comprise separate antennas. Similarly, in certain embodiments the amplifiers 306, 312 may comprise a single amplifier, while in other embodiments the amplifiers 306, 312 may comprise separate amplifiers. In addition, in certain embodiments multiple transmitting channels 220 may share one or more of the signal generators 302, filters 304, amplifiers 306, and/or antennae 308. Likewise, in certain embodiments, multiple receiving channels 222 may share one or more of the antennae 310, amplifiers 312, mixers 314, and/or samplers/digitizers 316.

The radar system 203 generates the transmittal radar signals via the signal generator(s) 302. The transmittal radar signals are filtered via the filter(s) 304, amplified via the amplifier(s) 306, and transmitted from the radar system 203 (and from the mobile platform 100 to which the radar system 203 belongs, also referred to herein as the “host mobile platform”) via the antenna(e) 308. The transmitting radar signals subsequently contact one or more objects (e.g. a tire 119 or a path or road on which the mobile platform 100 is travelling). The radar signals are then reflected, and travel in various directions, including some signals returning toward the host mobile platform 100. The radar signals returning to the host mobile platform 100 (also referred to herein as received radar signals) are received by the antenna(e) 310, amplified by the amplifier(s) 312, mixed by the mixer(s) 314, and digitized by the sampler(s)/digitizer(s) 316.

Returning to FIG. 2, in certain embodiments, the radar system 203 also includes, among other possible features, the memory 224 and the processing unit 226. The memory 224 stores information received by the receiver 222 and/or the processing unit 226. In certain embodiments, such functions may be performed, in whole or in part, by a memory 242 of a computer system 232 (discussed further below).

The processing unit 226 processes the information obtained by the receivers 222 for making various determinations regarding various mobile platform parameters, for example pertaining wear on the tires 119, air pressure in the tires 119, a speed of the mobile platform 100, a wheel slip of the mobile platform 100, and/or one or more conditions of a path on which the mobile platform 100 is travelling (e.g. if there is a hill or a bump upcoming), by way of certain non-limiting examples. In other examples, the information may similarly be utilized in determining a side-slip angle for the wheel and a body side-slip angle for the mobile platform 100 (e.g., in certain embodiments, body side-slip is determined based on longitudinal and lateral velocities, and wheel side-slip is determined based also on the mobile platform yaw rate, which can be determined using a radar mounted on the mobile platform, by looking at the path). In one embodiment, the processing unit 226 of the illustrated embodiment is capable of executing one or more programs (i.e., running software) to perform various tasks instructions encoded in the program(s). The processing unit 226 may include one or more microprocessors, microcontrollers, application specific integrated circuits (ASICs), or other suitable device as realized by those skilled in the art, such as, by way of example, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

In certain embodiments, the radar system 203 may include multiple memories 224 and/or processing units 226, working together or separately, as is also realized by those skilled in the art. In addition, it is noted that in certain embodiments, the functions of the memory 224, and/or the processing unit 226 may be performed in whole or in part by one or more other memories, interfaces, and/or processors disposed outside the radar system 203, such as the memory 242 and the processor 240 of the controller 204 described further below.

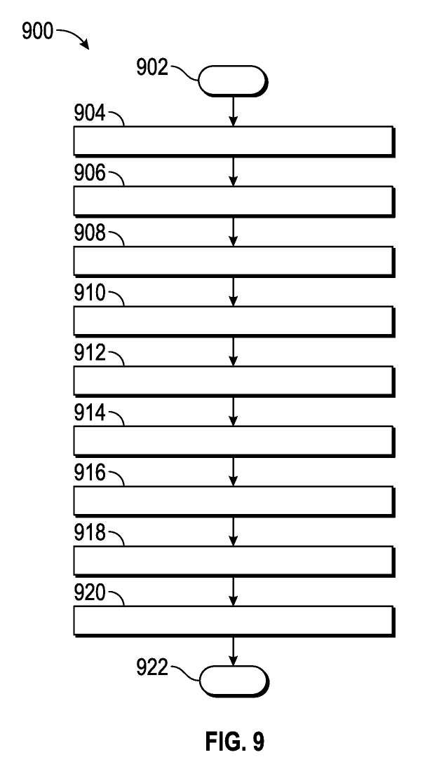

As depicted in FIG. 2, the controller 204 is coupled to the radar system 203. Similar to the discussion above, in certain embodiments the controller 204 may be disposed in whole or in part within or as part of the radar system 203. In addition, in certain embodiments, the controller 204 is also coupled to one or more other mobile platform systems (such as the electronic control system 128 of FIG. 1). The controller 204 receives and processes the information sensed or determined from the radar system 203, makes determinations pertaining to various mobile platform parameters (such as those discussed above), and implements appropriate mobile platform actions based on this information. In one embodiment, the controller 204 generally performs these functions in accordance with the method 900 discussed further below in connection with FIG. 9.

As depicted in FIG. 2, the controller 204 comprises the computer system 232. In certain embodiments, the controller 204 may also include the radar system 203, one or more components thereof, and/or one or more other systems. In addition, it will be appreciated that the controller 204 may otherwise differ from the embodiment depicted in FIG. 2. For example, the controller 204 may be coupled to or may otherwise utilize one or more remote computer systems and/or other control systems, such as the electronic control system 128 of FIG. 1.

As depicted in FIG. 2, the computer system 232 includes the processor 240, the memory 242, an interface 244, a storage device 246, and a bus 248. The processor 240 performs the computation and control functions of the controller 204, and may comprise any type of processor or multiple processors, single integrated circuits such as a microprocessor, or any suitable number of integrated circuit devices and/or circuit boards working in cooperation to accomplish the functions of a processing unit. In one embodiment, the processor 240 classifies objects using radar signal spectrogram data in combination with one or more computer vision models. During operation, the processor 240 executes one or more programs 250 contained within the memory 242 and, as such, controls the general operation of the controller 204 and the computer system 232, generally in executing the processes described herein, such as those of the method 900 described further below in connection with FIG. 9.

The memory 242 can be any type of suitable memory. This would include the various types of dynamic random access memory (DRAM) such as SDRAM, the various types of static RAM (SRAM), and the various types of non-volatile memory (PROM, EPROM, and flash). In certain examples, the memory 242 is located on and/or co-located on the same computer chip as the processor 240. In the depicted embodiment, the memory 242 stores the above-referenced program 250 along with one or more stored values 252 (such as, by way of example, information from the received radar signals and the spectrograms therefrom).

The bus 248 serves to transmit programs, data, status and other information or signals between the various components of the computer system 232. The interface 244 allows communication to the computer system 232, for example from a system driver and/or another computer system, and can be implemented using any suitable method and apparatus. The interface 244 can include one or more network interfaces to communicate with other systems or components. In one embodiment, the interface 244 includes a transceiver. The interface 244 may also include one or more network interfaces to communicate with technicians, and/or one or more storage interfaces to connect to storage apparatuses, such as the storage device 246.

The storage device 246 can be any suitable type of storage apparatus, including direct access storage devices such as hard disk drives, flash systems, floppy disk drives and optical disk drives. In one exemplary embodiment, the storage device 246 comprises a program product from which memory 242 can receive a program 250 that executes one or more embodiments of one or more processes of the present disclosure, such as the method 900 (and any sub-processes thereof) described further below in connection with FIG. 9. In another exemplary embodiment, the program product may be directly stored in and/or otherwise accessed by the memory 242 and/or a disk (e.g., disk 254), such as that referenced below.

The bus 248 can be any suitable physical or logical means of connecting computer systems and components. This includes, but is not limited to, direct hard-wired connections, fiber optics, infrared and wireless bus technologies. During operation, the program 250 is stored in the memory 242 and executed by the processor 240.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 240) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will similarly be appreciated that the computer system 232 may also otherwise differ from the embodiment depicted in FIG. 2, for example in that the computer system 232 may be coupled to or may otherwise utilize one or more remote computer systems and/or other control systems.

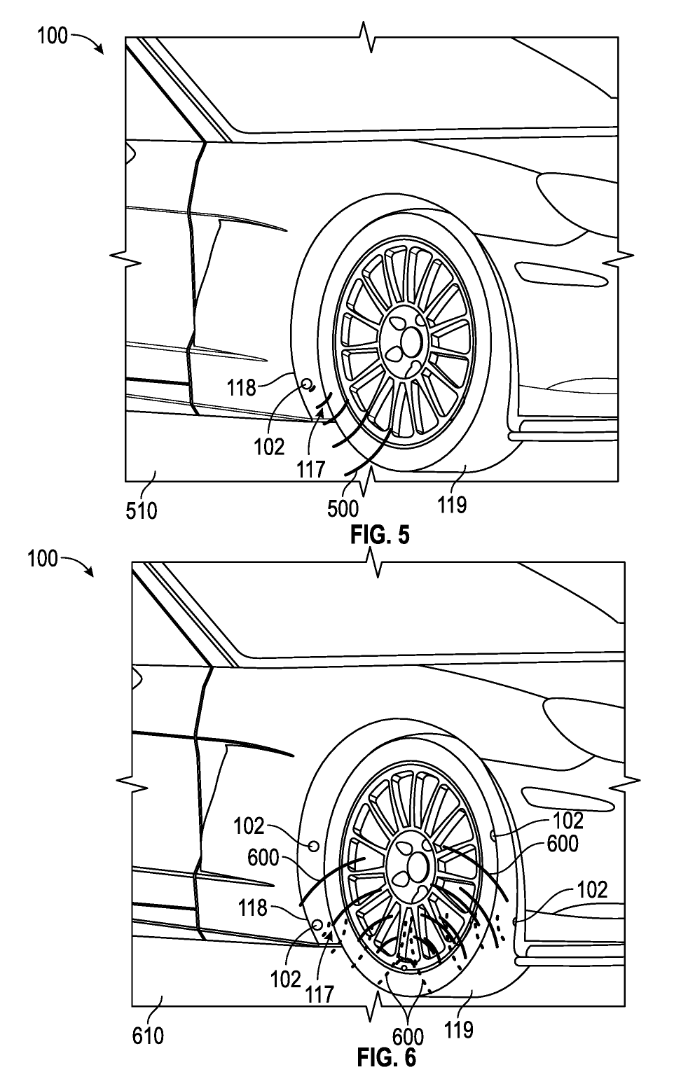

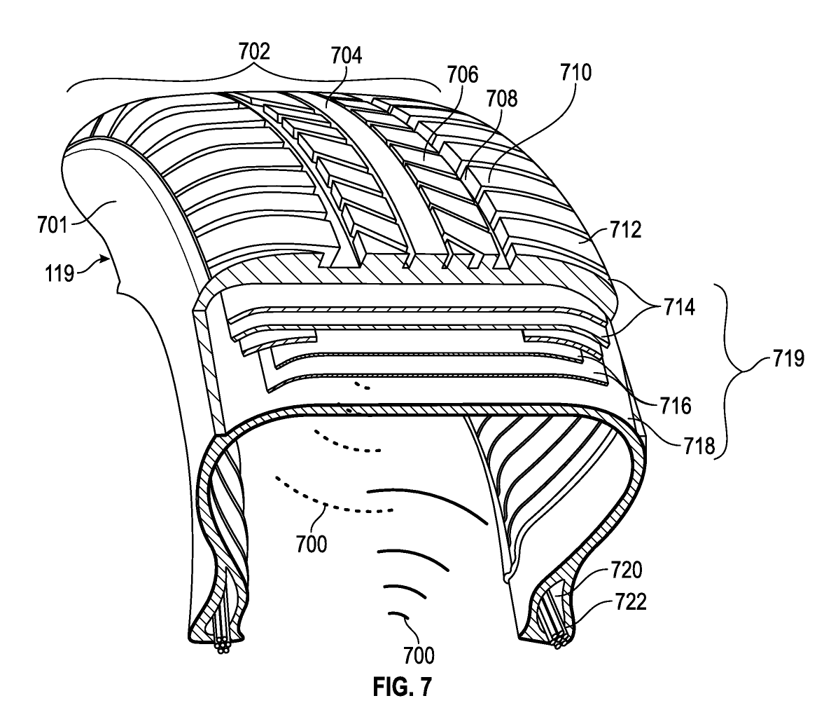

FIGS. 4-6 are schematic diagrams of a portion of a radar control system 102 as installed on various specific locations on a wheel assembly of a mobile platform, in accordance with exemplary embodiments. The radar control system 102 and the installation thereof as shown in FIGS. 4-6 can be incorporated in accordance with the mobile platform 100, wheel assembly 101, radar control system 102, and components thereof from FIGS. 1-3, in accordance with various exemplary embodiments. FIGS. 4-6 are discussed below with reference to FIG. 7, which depicts an exemplary tire 119 having a sidewall 701, patch (or thread area) 702, rib 704, thread block 706, grooves 708, sipes 710, shoulder 712, cap piles 714, steel belts 716 (the cap piles, steel belts 716, and radial piles 718 collectively comprising a mesh 719), bend chaffers 720, bead 722, and deflecting radar signals 700.

In the embodiment of FIG. 4, a radar control system 102 is installed on the drive shaft (axle) 134 of FIG. 1, and faces one of the tires 119 of FIG. 1. As shown in FIG. 4, the radar control system 102 transmits radar signals 400 toward the tire 119 and receives return radar signals 400 from the tire 119. In one embodiment, the radar signals 400 are transmitted toward and received from a side wall of the tire 119 (e.g. side wall 701 of FIG. 7). In addition, in one embodiment, the radar signals 400 are transmitted toward and received from a patch of the tire 119 (e.g. patch/tread area 702 of FIG. 7, with mesh 719 underneath). In one embodiment, the radar signals 400 are transmitted toward and received from a path (e.g. road 410) on which the mobile platform 100 is travelling. In certain embodiments, the radar signals 400 are transmitted toward and received from multiple of these locations. Also in certain embodiments, multiple radar control systems 102 may be installed on the same and/or different drive shafts (axles) 134 of FIG. 1. In one embodiment, a different radar control system 102 is installed on the drive shafts (axles) 134 facing each of the tires 119 such that each tire 119 has a respective associated radar control system 102.

In the exemplary embodiment of FIG. 5, a radar control system 102 is installed on the wheel well 117, and faces one of the tires 119 of FIG. 1. In various embodiments, such radar control systems 102 may be installed on the fender 118, elsewhere on the body 114 within or proximate the wheel well 117, or both. As shown in FIG. 5, the radar control system 102 transmits radar signals 500 toward the tire 119 and receives return radar signals 500 from the tire 119. In one embodiment, the radar signals 500 are transmitted toward and received from a side wall of the tire 119 (e.g. side wall 701 of FIG. 7). In addition, in one embodiment, the radar signals 500 are transmitted toward and received from a patch of the tire 119 (e.g. patch/tread area 702 of FIG. 7, with mesh 719 underneath). In one embodiment, the radar signals 500 are transmitted toward and received from a path (e.g. road 510) on which the mobile platform 100 is travelling. In certain embodiments, the radar signals 500 are transmitted toward and received from multiples of these locations. Also in certain embodiments, multiple radar control systems 102 may be installed on and/or proximate the same and/or different wheel wells 117 of FIG. 1. In one embodiment, one or more different radar control systems 102 are installed on the wheel wells 117 for each of the tires 119 such that each tire 119 has a respective associated radar control system 102.

In the embodiment of FIG. 6, one or more radar control systems 102 are formed as conformal antennas with the wheel assembly 101. For example, in the depicted embodiment, radar control systems 102 are formed as conformal antennas with the wheel well 117. As shown in FIG. 6, the radar control systems 102 transmit radar signals 600 toward the tire 119 and receive return radar signals 600 from the tire 119. In one embodiment, the radar signals 600 are transmitted toward and received from a side wall of the tire 119 (e.g. side wall 701 of FIG. 7). In addition, in one embodiment, the radar signals 600 are transmitted toward and received from a patch of the tire 119 (e.g. patch/tread area 702 of FIG. 7, with mesh 719 underneath). In one embodiment, the radar signals 600 are transmitted toward and received from a path (e.g. road 610) on which the mobile platform 100 is travelling. In certain embodiments, the radar signals 600 are transmitted toward and received from multiples of these locations. Also in certain embodiments, multiple radar control systems 102 may be installed as conformal antennas with multiple wheel wells 117 of FIG. 1 (e.g., in one embodiment, at least one such radar control system 102 is installed for each tire 119).

While FIGS. 4-6 depict different placement locations of the radar control systems 102 for the assembly 101 for the mobile platform 100, it will be appreciated that the locations may vary, and/or multiple locations may be utilized, in various embodiments. For example, in certain embodiments, radar control systems 102 are implemented for the mobile platform 100 in two or more of the locations depicted in FIGS. 4-6. In certain embodiments, radar control systems 102 are implemented for the mobile platform 100 in each of the locations depicted in FIGS. 4-6.

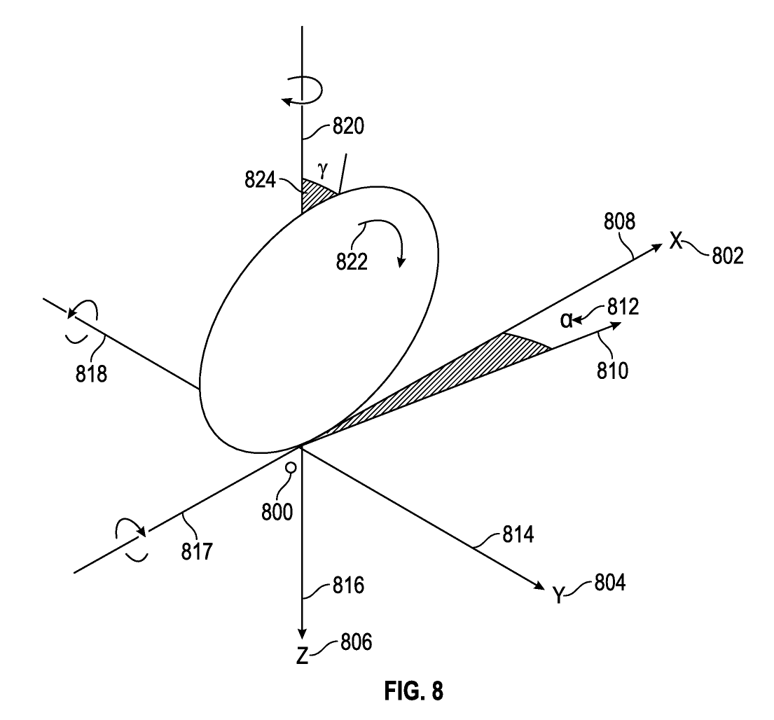

FIG. 8 is an illustration of various parameters that may be determined via the mobile platform 100, of FIG. 1, the radar control systems 102 of FIGS. 1-3, the installations of FIGS. 4-6, and the tire of FIG. 7, in accordance with various exemplary embodiments. FIG. 8 depicts, by way of reference, an origin 800, an x-axis 802 (e.g., a direction of wheel heading), a y-axis 804 (e.g., perpendicular to the x-axis), and a z-axis 806 (e.g., vertical, coming up from a path on which the mobile platform 100 is travelling). As shown in FIG. 8, the various parameters determined may include, by way of non-limiting examples: a tractive force 808 (Fₓ), a direction of wheel travel 810, a positive slip angle 812, a lateral force (F_{y}) 814, a normal force (F_{z}) 816, an overturning moment (Mₓ) 817, a rolling resistance (M_{y}) 818, an aligning torque (M_{z}) 820, a wheel torque 822, and a positive chamber angle 824.

FIG. 9 is a flowchart of a method 900 for remote monitoring using a radar control system installed within a wheel assembly of a mobile platform, in accordance with an exemplary embodiment. The method 900 can be implemented in connection with the mobile platform 100 of FIG. 1 the wheels assemblies 101, the radar control system 102 of FIGS. 1-3, and the installations and implementations of FIGS. 4-8, in accordance with exemplary embodiments. In various embodiments, the method can be scheduled to run at 902 based on predetermined events, and/or can run continually during operation of the mobile platform 100. Also in various embodiments, the determinations and processing steps are performed by one or more processing units mentioned above, such as the processing unit 226 and/or the processor 240 of FIG. 2.

As depicted in FIG. 9, the method 900 includes transmitting a first plurality of radar signals at 904. The radar signals are, in one example, transmitted via each of the plurality of transmitting channels 220 of the radar system 203 of the mobile platform 100 of FIG. 1 while the mobile platform 100 is operated on a path (e.g. a road). In certain embodiments, the radar signals are transmitted toward the tires 119 of the mobile platform 100 (e.g. toward the side walls 701 of FIG. 7, the patch 702 of FIG. 7, or both), for example as discussed above in connection with the radar control systems 102 in connection with FIGS. 2-7. Also in certain embodiments, the radar signals are also transmitted toward a path (e.g. a road) on which the mobile platform 100 is travelling, also for example as discussed above in connection with the radar controls systems 102 in connection with FIGS. 2-7.

After the radar signals are reflected from objects (e.g., the tires 119 and/or the path, similar to the discussions above), return radar signals are received by the radar system 203 at 906 of FIG. 9. In one example, the received radar signals are received via each of the receiving channels 222 of the radar system 203 of the mobile platform 100 (as referenced in FIGS. 1-3) after deflection from one or more of the tires 119 and/or the path.

In certain embodiments, direct radio frequency (RF) images are utilized at 908. For example, in certain embodiments, direct RF images are obtained via the return radar signals, and are used in making determinations regarding possible sidewall attenuation for the tires 119.

In certain embodiments, capacitive effects are utilized at 910. For example, in certain embodiments, steel wires (e.g. steel belts 716 of FIG. 7) inside the mesh of the tires 119 act as capacitors with a rubber compound that serves as a dielectric. In addition, forces and certain temperatures may cause changes in a distance between the wires, which can result in a change in capacitance for the wires (and can provide further indications regarding wear on the tires 119).

In certain embodiments, antenna array effects are utilized at 912. For example, in certain embodiments, the steel wires (e.g. steel belts 716 of FIG. 7) within the tires 119 may act as antennas. As such, forces may cause relatively small changes in the length of the wires, which can in turn result in changes in antenna returns (and can provide further indications regarding wear on the tires 119).

In certain embodiments, one or more tire characteristics are determined at 914. For example, using the techniques above, and/or other techniques, an evaluation of the return radar signals from the tires 119 may be utilized to determine various measures of wear on the tires 119, and/or to determine an air pressure for the tires 119.

In certain embodiments, one or more other mobile platform characteristics are determined at 916. For example, using the techniques above, and/or other techniques, an evaluation of the return radar signals from the tires 119 and/or from the path on which the mobile platform 100 is travelling may be utilized to determine a speed of the mobile platform (and/or wheels thereof), wheel slips for the various wheels of the mobile platform, side-slip angles for the wheels, a body side-slip angle for the mobile platform 100, and/or other mobile platform parameters.

In certain embodiments, one or more other characteristics of an environment surrounding the mobile platform are determined at 918. For example, using the techniques above, and/or other techniques, an evaluation of the return radar signals from the tires 119 and/or from the path on which the mobile platform 100 is travelling may be utilized to characteristics of the path. In certain embodiments, physical characteristics of an upcoming portion of the path (e.g. a bump or divot in the path) are determined at 918.

In certain embodiments, one or more other results from the determinations are implemented at 920. In certain embodiments, notices may be provided to a user (for example, a driver) when tires 119 require additional pressure, repair, and/or replacement. In certain embodiments, a suspension of the mobile platform is adjusted based on characteristics of an upcoming portion of the path (e.g. if a bump or divot is present). In various other embodiments, one or more other actions may be taken (for example, for braking control, steering control, engine control, and/or for one or more other systems) based on the determinations.

In various embodiments, the method 900 may terminate at 922 when the action is complete, or when further use of the radar system and/or the method 900 is no longer required (e.g. when the mobile platform is no longer in a propulsion mode and/or the current mobile platform drive and/or ignition cycle terminates).

Systems and methods are provided herein for remote RF monitoring are provided. The disclosed methods and systems provide for radar control systems that are installed within a wheel assembly of the mobile platform. In various embodiments, the installed radar control systems face the tires of the mobile platform and/or the path on which the mobile platform is travelling. Also in various embodiments, the installed radar control systems can be utilized in determining various parameters pertaining to the mobile platform (e.g. tire pressure, tire wear, wheel slip, side-slip angles for the wheels, and a body side-slip angle for the mobile platform) and to the path (e.g. a bump or divot in the path).

It will be appreciated that the disclosed systems, methods, and mobile platforms may vary from those depicted in the Figures and described herein. For example, the mobile platform 100, the wheel assembly 101, the radar control system 102, the radar system 203, the controller 204, and/or various components thereof may vary from that depicted in FIGS. 1-7 and described in connection therewith. In addition, it will be appreciated that certain steps of the method 900 may vary from those depicted in FIG. 9 and/or described above in connection therewith. It will similarly be appreciated that certain steps of the method described above may occur simultaneously or in a different order than that depicted in FIG. 9 and/or described above in connection therewith.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the appended claims and the legal equivalents thereof.

What is claimed is:

1. A mobile platform comprising:
a body including a wheel assembly; and
a radar system coupled to the wheel assembly.

2. The mobile platform of claim 1, further comprising:
one or more tires installed with the wheel assembly,
wherein the radar system includes one or more radar units, and each of the one or more radar units facing one of the tires.

3. The mobile platform of claim 2, wherein:
each tire includes a patch; and
each radar system includes:
a transmitter installed on the wheel assembly and configured to transmit radar signals to the patch of a respective one of the tires; and
a receiver installed on the wheel assembly and configured to receive radar signals from the patch of the respective one of the tires.

4. The mobile platform of claim 2, wherein:
each tire includes a side wall; and
each radar system includes:
a transmitter installed on the wheel assembly and configured to transmit radar signals to the side wall of a respective one of the tires; and
a receiver installed on the wheel assembly and configured to receive radar signals from the side wall of the respective one of the tires.

5. The mobile platform of claim 1, wherein each radar system includes:
a transmitter installed on the wheel assembly and configured to transmit radar signals to a path on which the mobile platform is travelling; and
a receiver installed on the wheel assembly and configured to receive radar signals from the path.

6. The mobile platform of claim 1,
wherein the wheel assembly includes one or more wheels and a drive shaft coupled to one or more of the wheels; and
the radar system is installed on the drive shaft.

7. The mobile platform of claim 1,
wherein the wheel assembly includes a fender; and
the radar system is installed on the fender.

8. The mobile platform of claim 1,
wherein the wheel assembly includes a wheel well; and
the radar system is installed on the wheel well.

9. The mobile platform of claim 1, wherein the radar system comprises a conformal antenna formed with the wheel assembly.

10. The mobile platform of claim 1, wherein the radar system comprises:
a transmitter installed on the wheel assembly and configured to transmit radar signals;
a receiver installed on the wheel assembly and configured to receive the radar signals after the radar signals have contacted one or more objects after transmission by the transmitter; and
a processor coupled configured to make determinations regarding one or more mobile platform parameters using the received radar signals.

11. A method comprising:
transmitting radar signals via a transmitter installed on a wheel assembly of a mobile platform;
receiving, via a receiver installed on the wheel assembly, the radar signals after the radar signals have contacted an object; and
determining, via a processor, one or more mobile platform parameters using the received radar signals.

12. The method of claim 11, wherein:
the mobile platform has one or more tires installed with the wheel assembly, and the method further comprises;
transmitting radar signals toward one or more of the tires; and
receiving the radar signals after the radar signals have contacted one or more of the tires.

13. The method of claim 12, wherein the determining the one or more mobile platform parameters comprises:
determining, via the processor, one or more tire parameters pertaining to one or more conditions of one or more of the tires.

14. The method of claim 11, wherein:
the transmitting the radar signals comprises transmitting radar signals toward a path on which the mobile platform is travelling; and
the receiving the radar signals comprises receiving the radar signals after the radar signals have contacted the path.

15. The method of claim 11, wherein the making determinations comprises determining a wheel slip, a wheel slip angle, or both, of a wheel of the mobile platform using the received radar signals.

16. The method of claim 11, wherein the making determinations comprises determining a body side slip angle of the mobile platform using the received radar signals.

17. The method of claim 11, wherein the making determinations comprises making determinations regarding one or more mobile platform parameters via a direct radio frequency image represented by the received radar signals.

18. The method of claim 11, wherein the step of making determinations comprises making determinations regarding one or more mobile platform parameters via a capacitive effect of the tire represented by the received radar signals

19. The method of claim 11, wherein the step of making determinations comprises making determinations regarding one or more mobile platform parameters via an antenna array effect of the tire represented by the received radar signals.

20. A mobile platform comprising:
a body including a wheel assembly;
a plurality of tires installed with the wheel assembly; and
a radar system installed on the wheel assembly, the radar system including one or more radar units, each of the one or more radar units facing one of the tires.
